(19) United States
(12) Patent Application Publication
(10) Pub. No.: US 2007/0241721 A1
(43) Pub. Date: Oct. 18, 2007

(54) DIRECT CURRENT POWER SUPPLY

(75) Inventors: Nir Weinstein, Bat-Hefer (IL); Michael Librus, Netanya (IL)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: EVEREADY BATTERY COMPANY, INC., St. Louis, MO (US)

(21) Appl. No.: 11/750,037

(22) Filed: May 17, 2007

Related U.S. Application Data
(63) Continuation-in-part of application No. 11/385,209, filed on Mar. 21, 2006.
(60) Provisional application No. 60/663,865, filed on Mar. 21, 2005.

(51) Int. Cl. H02J 7/00

(52) U.S. Cl. 320/114

(57) ABSTRACT

A portable electrochemical power supply for handheld electronic devices is disclosed. The power supply includes a housing with an electrical connector, a circuit board, and a removable electrochemical cell disposed therein. The circuit board carries power supply circuitry which receives electrical energy from the electrochemical cell and provides a power supply output for powering an external device.

This application is a continuation-in-part of copending U.S. patent application Ser. No. 11/385,209 filed Mar. 21, 2006, which claims the benefit of U.S. Provisional Application No. 60/663,865, filed Mar. 21, 2005.

### BACKGROUND OF THE INVENTION

This invention generally relates to a portable direct current power supply for a handheld electronic device. More particularly, this invention pertains to a direct current power supply for devices such as cellular phones.

The proliferation of portable battery powered devices, such as cellular telephones, has increased dramatically in the last several years and this trend is expected to continue. The phones typically use a rechargeable battery that is built into the phone to provide the needed power. The length of time that the battery powers the phone is dependent primarily upon the size of the battery and the number of energy consuming features built into the phone. In response to consumer demand, cell phone manufacturers incorporate into the phones features such as the ability to send and receive digital pictures and/or text messages. Unfortunately, the inclusion of these features usually places additional demands on the rechargeable batteries that power the cell phones. The net result is that the cell phones' run times become shorter and shorter due to the increased power demands. At the same time that the electrical demand placed on the battery is increasing, the size and weight of cell phones is decreasing in order to reduce the size of the phones. As the size of the cell phone is reduced, the size of the battery compartment built into the cell phone is also reduced. The existence of these two trends (i.e. increased electrical demand and reduced battery size) has caused many cell phone users to experience a failed telephone call or data transmission due to the depletion of their phone's battery at an inopportune moment. An additional trend that complicates resolving this problem is that most cell phones require a battery that has specific size and shape characteristics. In order to encourage consumers to purchase replacement batteries from the cell phone manufacturer, the cell phones are made with batteries that have unique shapes, locking mechanisms, voltage requirements, etc. Furthermore, the recharging port built into the cell phones limit the type of charger that can be connected to the cell phone. Collectively, these factors limit the consumer's ability to rapidly replace the depleted battery with another power supply.

Numerous attempts have been made to develop a suitable portable power supply for cellular telephones. For example, U.S. Pat. No. 6,127,801 discloses a power supply that includes a battery pack and a base unit which has bidirectional circuitry. The battery pack is made to snap into the base unit which is designed to be clipped onto the cellular telephone. Unfortunately, the battery pack and base unit tend to increase the size and weight of the cell phone, which is contrary to the consumer's desire, while also causing additional proliferation in the number of components the consumer needs to replace when the phone's battery is depleted. In another example, U.S. Pat. No. 6,709,784 discloses a unique battery pack that can be plugged into a cellular phone's contact to recharge the phone's built-in rechargeable battery and/or directly power the cell phone. This invention bundles the battery with the plug that allows the battery pack to be connected to the phone. Consequently, when the battery pack's battery is depleted the entire battery pack, including the plug, must be discarded which increases the consumer's cost.

Therefore, there exists a need for a portable direct current power supply that uses a commonly available battery that the consumer can readily insert into and remove from a reusable housing. The power supply needs to be lightweight, volume efficient and easily adaptable to a wide array of cell phones that utilize batteries of various shapes and sizes.

### BRIEF SUMMARY OF THE INVENTION

Aspects of the present invention address these matters, and others.

According to a first aspect of the invention, a portable battery powered power supply supplies electrical energy to an electrical appliance. The power supply includes a housing including a battery receiving region, power supply circuitry that receives electrical energy from a battery received in the battery receiving region, and an electrical connector attached for pivotal motion with respect to the housing. The connector is pivotable to a first position for connecting to a corresponding connector of the electrical appliance and a second position.

According to another aspect, a method includes pivoting an electrical connector of a portable battery powered power supply to an open position, connecting a corresponding connector of an electrically powered appliance to the electrical connector, using the power supply provide electrical energy to the electrical appliance, disconnecting the corresponding connector from the electrical appliance, and pivoting the electrical connector to a closed position in which the electrical connector is protected by a housing of the power supply.

According to another aspect, a portable battery powered power supply supplies electrical energy to an electrical appliance. The power supply includes a housing including a battery receiving region that receives a generally cylindrical battery along a longitudinal axis and a top, a bottom, and a front. The power supply also includes power supply circuitry that receives electrical energy from a battery received in the battery receiving region, a connector that provides an electrical connection to a corresponding connector of the electrical appliance, and a connector carrier including a protruding portion that carries the connector. The power supply circuitry is located between the bottom of the housing and the battery receiving region, and the connector carrier is attached to the housing for pivotal motion about a pivot axis that is perpendicular to the longitudinal axis. The connector carrier is movable to first position in which the protruding portion protrudes forward from the front of the housing at a location to the front of the power supply circuitry and to a second position in which the protruding portion protrudes rearward from the front of the housing at a location above the battery receiving region.

According to still another aspect, a portable battery powered power supply supplies electrical energy to an electrical appliance that includes a housing having a bottom, a first upstanding surface, and an appliance electrical connector that is accessible from the bottom of the appliance and spaced away from the upstanding surface. The power supply includes a housing including a battery receiving region, a bottom. The power supply also includes a second upstanding surface, power supply circuitry that receives electrical energy from a battery received in the battery receiving region, and an upwardly facing electrical connector that engages the appliance electrical connector. The spacing between the upwardly facing connector and the second upstanding surface is user adjustable to selectively accommodate a first electrical appliance in which the appliance electrical connector is spaced away from the first upstanding surface by a first distance and a second electrical appliance in which the appliance electrical connector is spaced away from the first upstanding surface by a second distance that is different from the first distance.

Those of ordinary skill in the art will appreciate still other aspects of the invention upon reading and understanding the appended description.

### BRIEF DESCRIPTION OF THE DRAWINGS

FIG. 1 is an exploded cross-sectional view of a portable power supply;

FIG. 2 is a cross-sectional view of an assembled portable power supply;

FIG. 3 shows a perspective view of a portable power supply, flexible connector and cellular phone;

FIG. 4 shows a flow chart of a process of this invention;

FIG. 5 is a functional block diagram of an electronic circuit;

FIG. 6 depicts the transfer function of an electronic circuit;

FIG. 7 is a top front perspective view of a portable power supply;

FIG. 8 is a top front perspective view of a portable power supply with a cover rendered transparent;

FIG. 9 is a bottom front perspective view of a portable power supply with a cover rendered transparent;

FIG. 10 is a perspective view of a printed circuit board and light pipe;

FIG. 11 is a perspective view of the interior of a bottom cover;

FIG. 12 is a perspective view of the exterior of a top cover;

FIG. 13 depicts a cross section of a portion of a connector housing;

FIG. 14 depicts steps in assembling a power supply.

FIG. 15 is a perspective view of a portable power supply depicting a contact support in an open position.

FIG. 16 is a perspective view of a portable power supply depicting a contact support in a closed position.

FIG. 17 is a perspective view of a portable power supply depicting a cover in an open position.

FIG. 18A is a side view of a power supply and a portable appliance.

FIG. 18B is a front view of power supply and portable appliance.

FIG. 19 is a method of using a power supply.

FIG. 20 is a perspective view of a power supply with a cover in a closed position.

FIG. 21 is a perspective view of a power supply with a cover in an open position.

FIG. 22 is a bottom view of power supply.

FIG. 23 is a sectional view of a power supply along the direction 23-23 of FIG. 15.

FIG. 24 depicts electrical connections between a connector and electrical contacts.

FIG. 25 is a bottom view of a connector carrier.

FIG. 26 is a side view of a latch member.

FIG. 27 is a rear view of a latch member, cover, and connector carrier along the line 27-27 of FIG. 16.

### DETAILED DESCRIPTION OF THE INVENTION

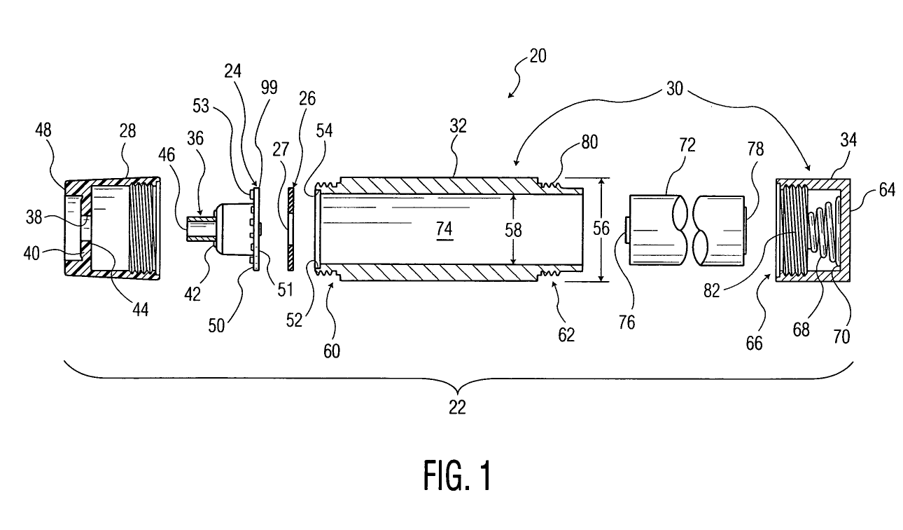

Referring now to the drawings and more particularly to FIG. 1, there is shown a cross-sectional view of a disassembled portable power supply 20 of this invention. The power supply generally comprises housing 22, circuit board 24, insulating ring 26, and electrochemical cell 72. Housing 22 includes an electrically nonconductive first section 28 and an electrically conductive second section 30 which can be further divided into first subsection 32 and second subsection 34. First section 28 is made of an electrically nonconductive and transparent material that will allow the consumer to view components on the circuit board. Second section 30 is made of aluminum which is an electrically conductive material. First section 28 and second section 30 can be secured to one another. Circuit board 24, commonly known as a printed circuit board (PCB), generally includes a thin electrically nonconductive disc shaped base member with a first planar surface 50 and a second planar surface 51. Electronic components, such as resistors, diodes, voltage modifiers, etc. are printed and/or otherwise attached to either of the base member's planar surfaces. Secured to the first surface are a tubular metal contact 36 and a light emitting diode 53. Secured to the circuit board's second surface is an arc shaped electrically conductive contact 99 positioned adjacent at least a portion of the board's perimeter. The arc shaped contact 99 on the second surface is in electrical contact with the electronic circuitry (not shown) secured to either the first planar surface and/or the second planar surface. A portion of the circuit board's tubular metal contact 36 extends through opening 38 in interior wall 40. The diameter of opening 38 is larger than the outside diameter of the tubular metal contact's distal end 46 but smaller than the diameter of flange 42 which abuts the inside surface 44 of wall 40 thereby limiting the distance which the tubular contact can extend through the opening. Wall 40 is sufficiently recessed to prevent the distal end 46 of tubular contact 36 from extending beyond the plane defined by the rim 48 of nonconductive first section 28. The insulating ring, which has an inner diameter that defines the size of opening 27 and an outer diameter, is made of an electrically nonconductive material. Ring 26 abuts the bottom 51 of circuit board 24 and ledge 52 in first subsection 32. The leading edge 54 of first subsection 32 extends past ring 26 and makes an electrically conductive contact with the arc shaped electrically conductive contact 99 on the bottom surface of circuit board 24 when the power supply is assembled. First subsection 32 has an outer diameter 56, an inner diameter 58, a leading end 60 and a trailing end 62. Both the leading and trailing ends are threaded to facilitate removably securing first subsection 32 to first section 28 and second subsection 34, respectively. Second subsection 34, also referred to herein as a cover, is a cup shaped component having a closed end 64 and a threaded opening 66 opposite the closed end. A coiled electrically conductive metal spring 68 is secured to the bottom inside surface 70 of cover 34.

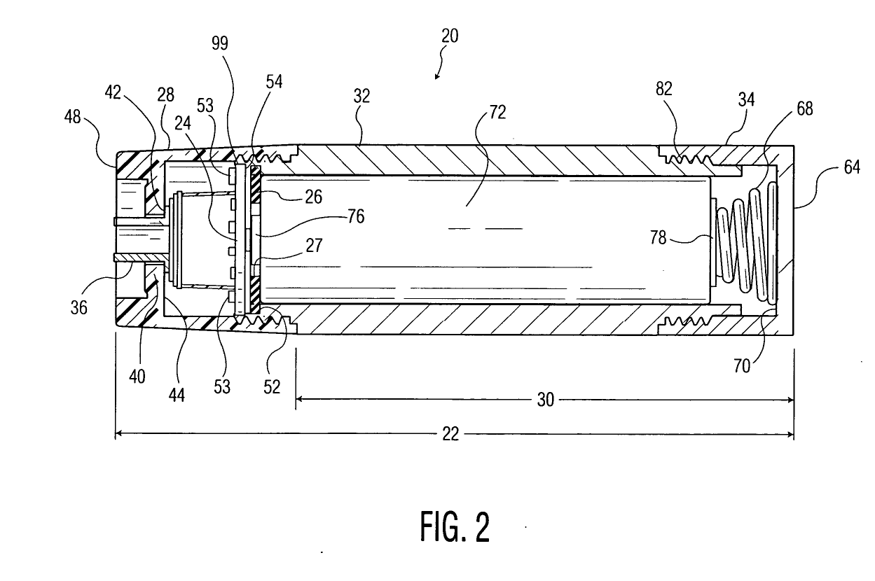

The assembled power supply disclosed in FIG. 2 may be assembled as follows. Circuit board 24 is oriented and inserted into the housing's first section 28 so that the tubular metal contact projects through opening 38 in the first section's interior wall 40 until the tubular contact's flange 42 abuts the interior surface 44 of wall 40. Insulating ring 26 is then inserted into the leading end 60 of the housing's first subsection 32. The outer diameter of disc 26 is slightly larger than the first inside diameter 58 of first subsection 32 and slightly smaller than the inside diameter of ledge 52 thereby insuring that disc 26 rests upon ledge 52 and does not block the leading edge 54 of first subsection 32. First section 28 is then secured to first subsection 32 by threading the first section onto the first subsection thereby trapping disc 26 and establishing an electrical path between the first subsection's leading edge 54 and the peripheral contact on the bottom surface 51 of circuit board 24. To minimize the cost and volume of the power supply, the housing was designed to eliminate a separate wire or other electrical conductor that could have been used to complete the electrical circuit from the cell's second terminal to the circuit board. This was accomplished by constructing first subsection 32 and second subsection 34 of aluminum which is an electrically conductive material. Other electrochemically conductive materials, such as nickel plated steel, copper or brass could be used instead of aluminum. If desired, the housing could be made of an electrically nonconductive material, such as plastic, provided an electrically conductive path is provided between the cell's second terminal and the circuit board. The electrically conductive path could be a thin, elongated strip of brass secured to the interior surface of the nonconductive housing and which wraps around or otherwise terminates at the leading edge 54 of the housing so as to make electrical contact with the arc shaped contact 99 of the PCB. Electrochemical cell 72 is then inserted into cavity 74 so that the cell's first terminal 76 extends through opening 27 in insulating disc 26 and contacts a centrally located electrical contact on the bottom surface of circuit board 24. The disc prevents electrical contact between the first terminal and other electronic components that may be located on the bottom of the circuit board. Second subsection 34, also referred to herein as a cover, is then secured to the trailing end 62 of first subsection 32 by manually rotating the cover around the periphery of the first subsection's outer wall so that the threaded ridges 80 on the outer surface of the first subsection engage the grooves 82 in the inner surface of the cover. Spring 68 forces the cell toward the circuit board thereby insuring the establishment and maintenance of good physical contact between the cell and the circuit board while also providing an electrically conductive path between the cell's second terminal and the cover.

Secured to the circuit board are the components of an electronic circuit 300. The components may be secured to the circuit board's first side 50, which is the side of the circuit board furthest away from the electrochemical cell, or to the circuit board's second side 51, which is located closest to the cell.

A first portion of the circuit functions as a sensing circuit and a second portion of the circuit functions as a boost circuit. The basic function of the sensing circuit is to detect the presence of a battery powered device to which the power supply is connected and then determine whether or not the electrochemical cell secured within the power supply's housing will be able to provide a current with sufficient amperage and voltage to operate the device and/or recharge a rechargeable battery that forms a part of the device. If one or more of the device's electrical characteristics that the sensing device can detect, such as electrical resistance, is not acceptable to the sensing circuit, the sensing circuit will not allow the boost circuit to supply power to the device. Similarly, if the sensing circuit determines that the cell's electrochemical capacity has been sufficiently depleted to prevent the cell from providing an adequate current to the boost circuit, then the sensing circuit will not allow the boost circuit to operate. In one embodiment, the sensing circuit can be made to attempt to detect the presence of a suitable device and electrochemical cell approximately two times per second. From the consumer's point of view, the power supply is always “on”. However, since the drain on the cell that powers the sensing circuit is very small the cell can power the sensing circuit for long periods of time before the cell must be replaced.

The function of the boost circuit is to transform the cell's voltage, which is also referred to herein as the boost circuit's input voltage, from a first voltage to a second higher voltage. Preferably, the boost circuit's input voltage, which is defined as the cell's closed circuit voltage prior to discharging the cell in any circuit that depletes more than one percent of the cell's theoretical electrochemical capacity, is below 1.90V. The boost circuit receives the cell's energy, which has a voltage below 1.90V, and transforms it to produce an output voltage greater than 3.00V which is the minimum voltage needed to power many commercially available cellular telephones. If desired, the boost circuit could be configured to transform the output voltage to a different voltage such as 3.60V. The boost circuit is not activated until the sensing circuit determines that the cell's output voltage and the device's electrical characteristics meet predefined criteria such as a minimum closed circuit voltage for the cell and a maximum electrical resistance for the device.

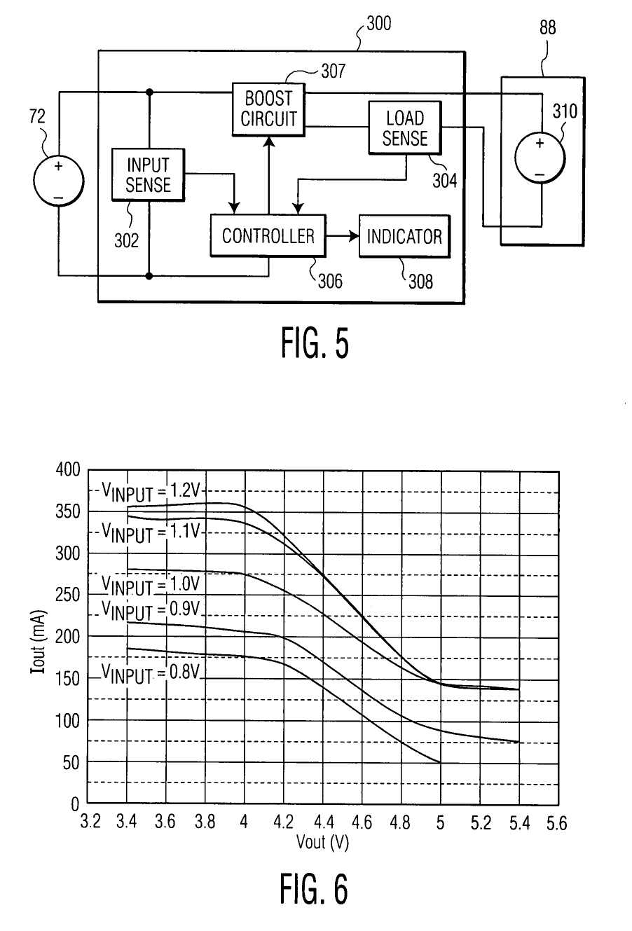

With reference to the functional block diagram of FIG. 5, the electronic circuit 300 is in operation operatively connected between the electrochemical cell 72 and a battery 310 which powers an electrical device 88 such as a cellular telephone.

The electronic circuit 300 is powered by the electrochemical cell 72. The electronic circuit 300 converts the energy provided by the electrochemical cell 72 to a voltage and current level suitable for providing power to the electrical device 88.

In one embodiment, the electronic circuit 300 receives input power from an alkaline AA cell having a nominal voltage of 1.5 volts direct current (VDC) and produces an output voltage greater than about 3.0 volts direct current (VDC). More particularly, the circuit 300 provides charge current to a lithium ion battery 310 having a nominal voltage of 3.6 volts direct current (VDC). The electronic circuit 300 includes a controller 306 operatively connected to charging/boost circuitry 307 which in turn provides electrical energy to the lithium ion battery 310. Input sense circuitry 302 is operatively connected to the electrochemical cell 72 and provides the controller 306 with an indication of the voltage supplied by the cell 72. Load sense circuitry 304 is operatively connected to the load 310 and provides the controller 306 with a signal indicative of the current drawn by the load 310. A human readable indicator 308 such as one or more light emitting diodes (LEDs) indicates the status of the power supply.

An exemplary graph showing the relationship between the output current and voltage supplied to the lithium ion battery 310 and the input voltage supplied by the electrochemical cell 72 is shown in FIG. 6. Over a first range of voltages near the nominal 3.6 volt direct current (VDC) voltage of the lithium ion battery 310, the circuit 300 functions as a current source to provide a substantially constant charging current to the battery 310. As the battery 310 voltage increases with increasing battery charge, the current supplied to the battery 310 is reduced until the battery 310 is substantially charged.

With continuing reference to FIG. 5, the electronic circuit 300 also includes input sense circuitry 302 which senses the input voltage provided by the electrochemical cell 72. Above a first threshold voltage, for example approximately 1.1 volts direct current (VDC), the current supplied by the charging circuitry 307 remains substantially constant as a function of input voltage. As the cell 72 voltage decreases, the current supplied by the charging circuitry 307 likewise decreases. As the cell 72 voltage decreases below a second threshold, for example approximately 0.6 volts direct current (VDC), the controller 306 enters an idle mode or low power mode in which the boost circuit 307 is disabled and the charging circuitry 307 no longer supplies power to the lithium ion battery 310.

The load sensing circuitry 304 senses the presence of a load at the circuit's output. If no load is detected, the controller 306 enters an idle or low power mode in which the boost circuitry 307 is disabled so as to conserve energy in the cell 72. If, on the other hand, the load sensing circuit 304 indicates the presence of a suitable load, the boost circuit is enabled, and the electronic circuitry 300 provides a recharging current to the battery 310. The controller 306 causes the indicators 308 to flash to indicate that the device is providing power to the load.

In one embodiment, the electronic circuit 300 is implemented using the TEC 103 integrated circuit available from Techtium Ltd. of Tel Aviv, Israel. Of course, other embodiments of the circuit can also be implemented.

While the above description has focused on recharging the lithium ion battery 310, the electronic circuit 300 may also provide an additional or auxiliary power source while the electrical device 88 is operational, or may be used to power the device directly.

Other embodiments of the electronic circuit 300 may also be implemented. Thus, for example, the circuit may be configured to provide voltage and/or current levels suitable for charging battery technologies other than lithium ion. The circuit may be configured to provide a suitable voltage and/or current to directly power a load in the absence of a battery 310. Moreover, one or both of the input and load sense functions may be omitted.

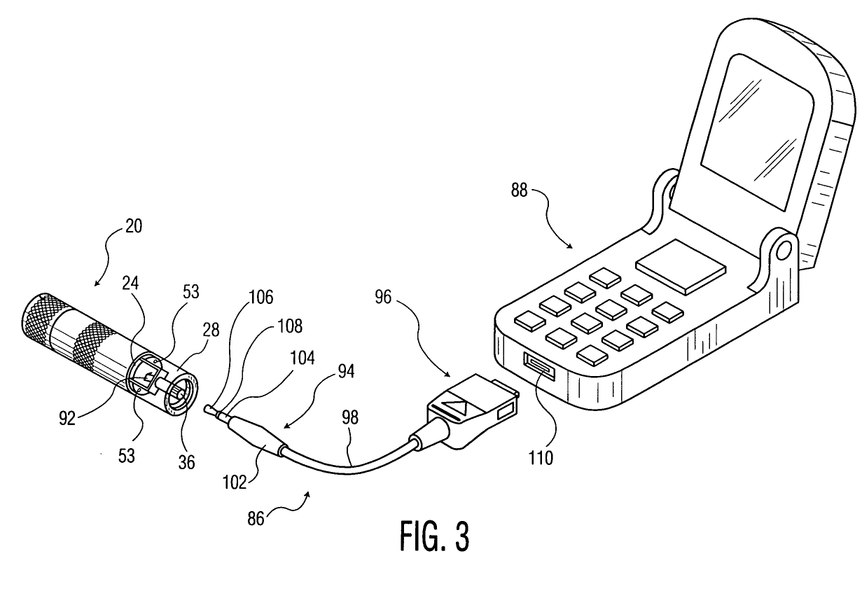

Shown in FIG. 3 is an exploded view of the following three articles: a portable power supply 20 of this invention; an elongated, flexible, electrically conductive connector 86; and a cellular telephone 88. Power supply 20 includes a transparent first section 28 through which can be seen two light emitting diodes 53; tubular metal contact 36 and circuit board 24. Located between one end of tubular contact 36 and printed circuit board 24 is spring contact 92 which is electrically isolated from tubular contact 36. Spring contact 92 is electrically connected to one of the electrochemical cell's terminals and tubular contact 36 is electrically connected with the cell's other terminal. Flexible connector 86 includes first connecting means 94 on one end thereof and second connecting means 96 on the opposite end thereof. The connecting means are electrical plugs that can be used to establish electrical connection between a power supply and a device. The two plugs are electrically connected and physically secured to one another by a flexible wire that includes a metal conductor coated by an electrically nonconductive material. First connecting means 94 includes an outer insulated portion 102, a first conducting portion 104, a second conducting portion 106 and an insulating sleeve 108. First conducting portion 104 is a tubular metal contact that is designed to form an interference fit with the inside diameter of tubular contact 36. Insulating sleeve 108 lines the inside surface of first portion 104 and extends slightly beyond the distal end of first portion 104 thereby forming an electrically insulated path through which second conducting portion 106 extends. When the consumer grasps outer insulated portion 102 and inserts first connecting means 94 into the power supply's tubular metal contact 36, first conducting portion 104 establishes electrical contact with tubular contact 36 and second conducting portion 106 establishes electrical contact with spring 92. Second conducting means 96 is sized to fit in the cavity defined by port 110 in cellular telephone 88. Because manufacturers of cellular phones may use one of several different ports, and each port is uniquely sized relative to the other ports, the consumer needs to select a flexible electrically conductive connector that has a second connecting means that is properly configured to match the port in their phone. If a consumer needs to sequentially power two different cellular telephones with different size ports, such as could occur when the consumer exchanges their old cell phone for a new cell phone, the power supply is still usable provided a flexible connector that will fit the new phone is selected. When the flexible connector's first connecting means is plugged into the power supply's tubular contact and the second connecting means is plugged into the device's port, the power supply's sensing circuit detects the cellular phone and allows the power supply to send a current to the phone provided one or more predefined characteristics are detected by the sensing circuit.

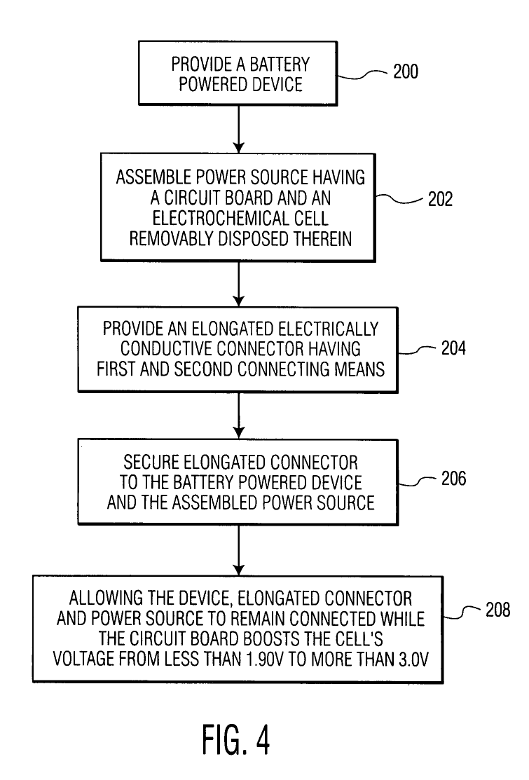

As shown in FIG. 4, a process of this invention includes the following steps. In step 200, providing a battery powered device. The device includes a port to which an electrically conductive connecting means can be secured. In step 202, assembling a portable power supply. The power supply includes a housing having a removable electrochemical cell disposed therein. In step 204, an elongated electrically conductive connector is provided. The connector has a first connecting means secured to one end and a second connecting means secured to the other end of the connector. Step 206 represents securing the first connecting means to the power supply and the second connecting means to the device's port. In step 208, the device, elongated connector and power supply are allowed to remain connected while the printed circuit board receives an input voltage from the cell and provides an output voltage to the device wherein the input voltage is less than 1.90V and the output voltage is greater than 3.00V.

A preferred battery for use in a portable direct current power supply of this invention is a single primary cylindrical battery that incorporates a single anode that includes lithium, a single cathode that includes iron disulfide and a nonaqueous electrolyte. The preferred battery has a jellyroll construction wherein strips of the anode (lithium), cathode (iron disulfide) and separator are rolled to form a coil which is then inserted into the container that forms the body of the cell. Jellyroll cells are known to have high anode-to-cathode interfacial surface area which facilitates high rate discharge. In a preferred embodiment, at least 20 percent of the cell's theoretical electrochemical capacity is discharged at 1.40V or higher and the cell has an initial unaltered open circuit voltage between 1.50V and 1.90V. Other suitable cell chemistries include: (1) a primary cylindrical cell that incorporates zinc, an alkaline electrolyte and one or more electrochemically active materials selected from the group consisting of manganese dioxide, nickel oxyhydroxide and silver oxide; (2) a metal/air cell that incorporates zinc, an alkaline electrolyte and has air access port(s) and/or an air manager; (3) rechargeable cells that utilize an alkaline electrolyte and electrodes that include nickel and cadmium or nickel and a metal hydride; and (4) cells that utilize a zinc anode, manganese dioxide in the cathode and an acidic electrolyte. To accommodate commercially available cell sizes, the power supply's housing is made to define a cylindrical cavity that will accept a single electrochemical cell, also referred to herein as a battery, such as an R6 (AA), R03 (AAA), R14 (C) or R 20 (D) size battery. Because the power supply utilizes commonly available batteries, there is no need to purchase several uniquely shaped batteries to power several different devices owned by a consumer. The power supply of this invention allows the consumer to use a single power supply to sequentially power many different devices.

One of the issues that may need to be considered in the design of a power supply that includes an electrochemical cell is the management of heat that is generated when the cell is discharged. For example, when an R6 size battery that includes zinc, manganese dioxide and an alkaline electrolyte is continuously discharged at a one amp constant current drain rate, the exterior surface of the cell can heat up to 45° C. If the peripheral surface of the cell contacts the interior surface of the power supply's housing, heat will be conductively conveyed to and through the cell's housing. If the power supply is then picked up by an unsuspecting consumer, such as a child, the elevated temperature of the power supply's housing could cause the consumer to suddenly drop the power supply resulting in harm to the consumer and/or damage to the power supply and/or device. One way to safely manage the heat generated by the battery is to minimize the contact between the recently discharged cell and the interior surface of the housing, particularly the amount of contact between the interior surface of the housing's sidewall and the battery's circumferential surface. Preferably, contact between the cell's circumferential surface area and the sidewall of the housing is limited to less than 5% of the cell's circumferential surface area which would insure that at least 95% of the cell's circumferential surface area does not contact the interior surface of the housing. This can be accomplished by incorporating into the housing a mechanism that centers the cell in the cavity upon insertion of the cell and then keeps the cell centered in the cavity regardless of how the power supply is oriented by the consumer. For example, insulating disc 26 (see FIG. 1) could be made of a sufficiently thick material to allow for the formation of ridges and/or grooves in the bottom surface 51 thereof that would limit side-to-side movement of the cell's first terminal 76 thereby restricting lateral movement of the cell. Similarly, the interior bottom surface 70 of cover 34 could be contoured to engage ridges and/or recesses on the cell's second terminal 78 and thereby prevent lateral movement of the cell in the cavity. Another way to manage the transfer of heat from the cell to the power supply's housing is to insert a tubularly shaped thermal insulator between the cell and the interior surface of the housing's sidewall. The diameter of the tubularly shaped insulator would need to be greater than the diameter of the cell and less than the inside diameter of the housing. Alternatively, a thermally insulating material could be applied to the housing's exterior surface. Yet another way to manage heat transfer is to insure that the inside diameter of the housing is at least 5% larger than the outside diameter of the cell thereby insuring the existence of an air gap between the housing and the cell's circumferential surface area.

The housing of the power supply shown in FIG. 1 could be made with one or more openings through the housing to facilitate the movement of gases, such as oxygen and/or hydrogen, into or out of the housing. Certain batteries, such as cylindrical batteries that include powered zinc, manganese dioxide and an alkaline electrolyte, are known to produce hydrogen gas during discharge. The gas slowly escapes through the battery's housing by permeating through the cell's seal assembly. Openings through the power supply's housing will allow the gas to escape thereby avoiding a dangerous buildup of hydrogen gas in the power supply's housing. Another reason to incorporate openings through the housing is to allow oxygen in the air to access the electrochemical cell if the cell is an air cell which uses the oxygen as one of the cell's reactants. The oxygen would flow through openings in the power supply's housing and then through the openings in the electrochemical cell's housing where the oxygen could react with the cell's other electrochemically active material to produce an electric current. The openings could also be used to dissipate the heat generated by the cell as it is discharged.

Because the power supply of the present invention is intended for use by consumers in their day-to-day activities when the device and power supply may be temporarily stored in a purse, briefcase or coat pocket, the total volume occupied by the power supply needs to be minimized. Thus the volume occupied by the housing should be minimized relative to the volume occupied by the electrochemical cell. Preferably, the volume of the electrochemical cell should be at least 85% of the total volume occupied by the power supply. More preferably, the volume of the electrochemical cell should be at least 90% of the total volume occupied by the power supply. To accomplish this objective, a power supply of this invention is preferably designed to include an electrochemical cell having an outer diameter that is no less than 95% of the inside diameter of the cavity into which the cell is inserted.

The operation of a preferred power supply of this invention will now be described. A primary (nonrechargeable) battery having a first terminal electrically connected to a single anode, a second terminal electrically connected to a single cathode, and an unaltered open circuit voltage below 1.90V, is inserted through an opening into a partially enclosed housing that includes a printed circuit board and an electrical connector disposed through the housing. A cover is secured over the opening thereby providing an electrically conductive path between the cell's second terminal and an electrically conductive portion of the housing that establishes an electrical connection with the printed circuit board. The printed circuit board includes a sensing circuit that detects the presence of a properly inserted cell having a minimum voltage. The printed circuit board further includes a light emitting diode that is illuminated for a brief period of time to signal the consumer that the power supply is operational. The consumer then secures one end of an elongated electrically conductive connector to the power supply's electrical connector that extends through the housing and the second end of the elongated connector is secured to a cellular telephone's charging port. The power supply's sensing circuit detects the presence of a cell phone that can be recharged by the power supply and then activates the printed circuit board's boost circuit which increases the cell's voltage from less than 1.90V to 3.00V or higher. The power supplied by the power supply is used to recharge the cell phone's rechargeable battery and/or to directly power the cell phone. The sensing circuit monitors the cell's voltage and reduces or stops the power supply's output if the cell's voltage falls below a predetermined minimum voltage. For example, if the cell's voltage drops below a first threshold voltage, such as 1.10V, then the power supply's output is reduced. When the cell's voltage drops below a second threshold voltage, such as 0.60V, then the power supply's output is reduced to 0.0v.

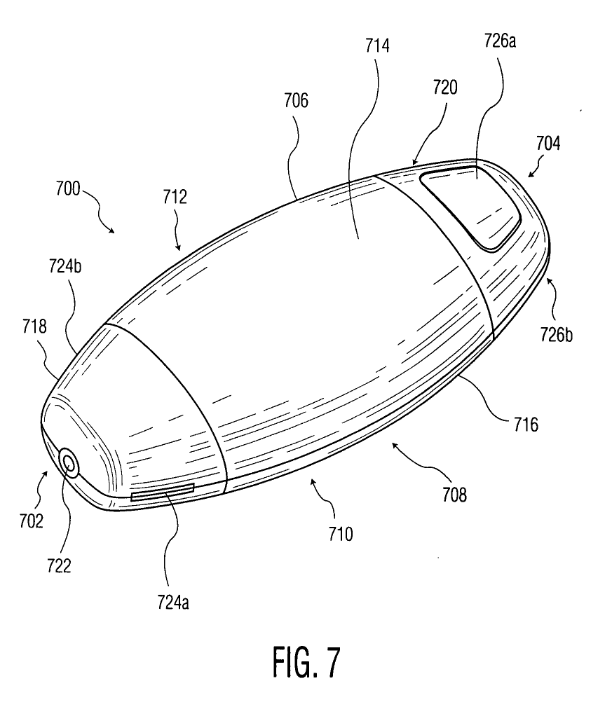

Turning now to FIG. 7, a portable power supply 700 has top 702, bottom 704, front 706, rear 708, and first 710 and second sides 712. As the power supply 700 is readily portable, the foregoing descriptions are intended to provide a consistent frame of reference with which to describe the power supply itself 700 and do not necessarily correspond to the reference frame of a user or otherwise to the external environment. As illustrated in FIG. 7, the power supply 700 is adapted to receive two (2) AA size cells. Also as illustrated, the power supply 700 has exterior dimensions of 83.4 millimeters length×41 millimeters wide×22.8 millimeters deep and takes the shape of an ovoid having generally flattened front 706 and rear 708 surfaces.

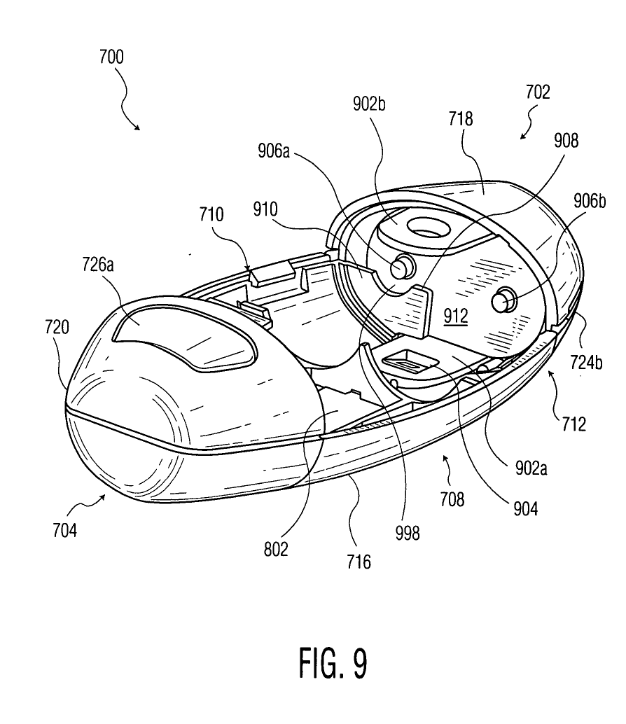

The power supply 700 includes a front cover 714, rear cover 716, a top cover 718, and a bottom cover 720 which may advantageously be molded or otherwise formed using a polymer such as acrylonitrile butadiene styrene (ABS). Accessible through an opening which is generally centered in the top surface of the top cover 718 is an electrical connector 722 such as a female jack. A first human readable status indicator 724a is visible on the first side 710 of the top cover 718. A corresponding second human readable status indicator 724b (see FIG. 9) is likewise visible on the second side 712. A first latch 726a is located at the front 706 of the bottom cover 720. A corresponding second latch 726b (again not visible in the perspective view of FIG. 7) is likewise located at the rear 708 of the bottom cover 720.

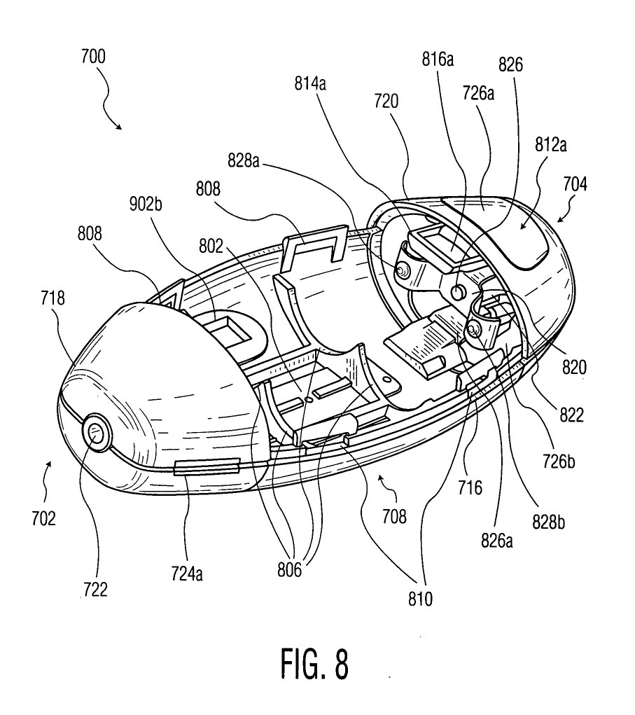

FIGS. 8 and 9 depict respective top front and bottom front perspective views of the portable power supply 700 with the front cover 714 rendered transparent for ease of illustration. The portable power supply 700 includes a battery receiving region 802 adapted to receive first and second generally cylindrical batteries. The rear cover 716 includes front facing, generally arcuate battery supports 806. The front cover 714 contains similar, rear facing supports.

Protrusions 808 and recesses 810 disposed at the periphery of the rear cover 716 snappingly engage corresponding recesses and protrusions disposed at the periphery of the front cover 714. More particularly, the clips and recesses are configured to facilitate assembly of the cover portions 714, 718 into a unitary assembly but to resist ready disassembly by a user.

With additional reference to FIG. 11, the bottom cover 720 is removably attached to the power supply 700 so as to allow a user to insert and remove the batteries. The bottom cover 720 carries the latches 726a, 726b, which are preferably identical, and the contact member 820.

The latches 726a, 726b include user operable actuating portions 812a, 812b which are accessible through respective material free regions in the bottom cover 720. As illustrated, the actuating portions 812a, 812b are substantially flush with the outer surface of the cover 720. The latches 726a, 726b also include shoulder portions 1102a, 1102b having a dimension greater than that of the material free regions and which aid in retaining the latches 726a, 726b in position inside the bottom cover 720.

The latches 726a, 726b also include cover engaging portions 814a, 814b which extend upwardly from the bottom cover 720. The cover engaging portions 814a, 814b include recesses 816a, 816b, material free regions, catches, or the like which engage corresponding protrusions disposed in the inner surface of the front 714 and rear 716 covers. The respective protrusions have generally curved or wedge shaped profiles so that the height of the protrusions is relatively lower near the bottom of the respective covers and relatively higher near the top. As will be appreciated, such an arrangement facilitates the assembly of the bottom cover 720 to the front 714 and rear 716 covers but prevents ready disassembly unless the actuating portions 812a, 812b are depressed. The cover engaging portion 814a, 814b may also be configured to provide a protrusion which engages a corresponding recess or latch portions on the covers 714, 716.

The contact member 820 is fabricated from an electrically conductive, resilient material such as AISI 302 chromium nickel stainless steel. The contact member 820 is supported by a boss 822 which extends generally inwardly from the bottom inner surface of the bottom cover. A post 824 extends through a corresponding aperture in the contact member 820 so as to aid in positioning the contact member 820. The post 824 may be heat staked or otherwise deformed so as to hold the contact member 820 in place. Other fastening techniques, such as a split post which snappingly engages the aperture, mechanical fasteners such as screws, adhesives, and/or interference fits are also contemplated.

The contact member 820 includes tabs 826a, 826b which engage corresponding slots or recesses in the inner portion of the latches 726a, 726b. The resilient nature of the contact member 820 tends to urge the latches 726a, 726b outwardly toward the bottom cover 720 until their respective shoulders 1102a, 1102b contact the inner surface thereof. The contact member 820 also includes first 828a and second 828b battery contacts which provide electrical connections to the terminals of batteries inserted in the battery receiving region 802. The resilient nature of the contact member aids in providing a reliable electrical connection with batteries installed in the battery receiving region 802.

As illustrated, the bottom cover 720 and associated components have rotational symmetry so that the contact member 820 may be installed in the bottom cover in either of two (2) 180° rotationally opposed positions; the cover latches 726a, 726b are interchangeable. Moreover, the bottom cover 720 may be likewise installed on the power supply in either of two (2) 180° rotationally opposed positions. A particular advantage of such a configuration is that assembly of and installation of the bottom cover 720 on the power supply 700 is simplified.

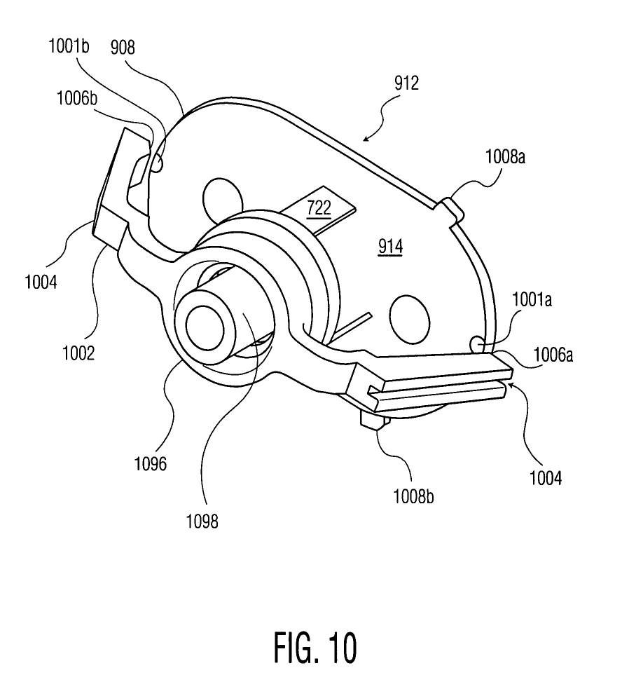

Returning now to FIGS. 8 and 9 and with additional reference to FIG. 10, the top cover 718 includes first 902a and second 902b attaching members which snappingly engage the rear 716 and front 714 covers, respectively. The attaching members 902a, 902b are preferably keyed so that the top cover 718 cannot be installed in the incorrect orientation. More particularly, the first attaching member 902a includes a generally square aperture which is adapted to engage a correspondingly shaped protrusion 904a on the inner surface of the rear cover 712. The second attaching member 902b likewise includes a generally circular aperture which is adapted to engage a correspondingly shaped protrusion on the inner surface of the front cover 714. The respective protrusions 904 have generally wedge shaped profiles so that the height of the protrusions is relatively lower near the top of the respective covers and relatively higher near the bottom. As will be appreciated, such an arrangement facilitates the assembly of the top cover 718 to the front 714 and rear 716 covers but prevents ready disassembly by the user or otherwise.

A PCB 908 is carried by the top cover 718. Disposed on a first side 912 of the PCB 908 are first and second battery contacts 906a, 906b which are adapted to make electrical contact with the respective terminals of batteries inserted in the battery receiving region 802. Battery polarity members 910, which extend from the inner surfaces of the front 714 and rear 716 covers, prevent the battery located nearer the first side 710 from being inserted with the improper polarity. More particularly polarity members 910 associated with each of the front and rear covers cooperate to form an aperture 998 of a size which allows the positive terminal of a desired size battery (AA in the illustrated embodiment) to protrude through the aperture 998 so as to contact the first battery terminal 906a. The aperture 998 has a dimension smaller than the outer diameter of the desired size battery so that the negative terminal cannot make such a contact.

The PCB 908 also carries power supply circuitry which converts the energy supplied by the batteries to the desired voltage and/or current levels at the power supply output. In one implementation, the power supply circuitry may function substantially as described above in connection with the circuit board 24 and the circuitry 300. As illustrated in connection with FIGS. 7-11, however, the batteries are connected electrically in series. Consequently, the power supply circuit input voltage is ordinarily twice that provided to the circuitry of circuit board 24 such that the operation of the circuitry 300 would be adjusted accordingly. One consequence of such an arrangement is that the power supply 700 may advantageously be used to supply GSM mobile phones and other electrical appliances having relatively higher power requirements than can be effectively supplied by only a single battery.

FIG. 10 depicts the second side 914 of the PCB 908, the connector 722, light sources 1001a, 1001b such as light emitting diodes (LEDs), and a light pipe 1002. The connector 722, which is electrically connected to the output of the power supply circuit, is carried on the second side 914 of the PCB 908. The connector 722 is positioned to align with a corresponding opening in the top cover 724 when the PCB 908 is installed in the power supply 700 so that the connector is accessible from the exterior thereof. Keys 1008a, 1008b, which engage corresponding slots in the inner surface of the top cover 718, prevent the PCB 908 from being installed in the incorrect orientation.

As illustrated, the connector 722 also includes a generally tubular or cylindrical portion 1098 which passes though a material free region of the light pipe 1002. The exterior of the light pipe 1002, which is fabricated from polycarbonate or other suitable material, has generally bow or arcuate shape which generally conforms to the shape of the top cover 718 so that the light pipe may be inserted therein. The exterior surface of the light pipe 1002 includes grooves or slots 1004 which engage corresponding bosses which protrude inwardly from the inner surface of the top cover 718 so as to aid in properly positioning the light pipe 1002.

The light sources 1001a, 1001 b, which are electrically connected to the power supply circuit so as to provide an indication of the circuit status, are positioned so that, when the PCB 908 and the light pipe 1002 are installed in power supply, the light sources 1001a, 1001b are in optical communication with corresponding light receiving portions 1006a, 1006b of the light pipe 1002. The light pipe 1002 further aligns with a light transmissive or material free region of the top cover 718 so as to provide the status indicators 724a, 724b which are visible therethrough. Additionally, some or all of the annular portion 1096 of the light pipe 1002 may be disposed so as to be visible between the cylindrical portion 1098 of the connector 722 and the corresponding material free region of the top cover 718. Such an arrangement can be used to provide an additional human readable indication at the top of the power supply 700. As illustrated, the top cover 718 and light pipe 1002 have rotational symmetry so that the light pipe 1002 may be installed in the bottom cover in either of two (2) 180° rotationally opposed positions

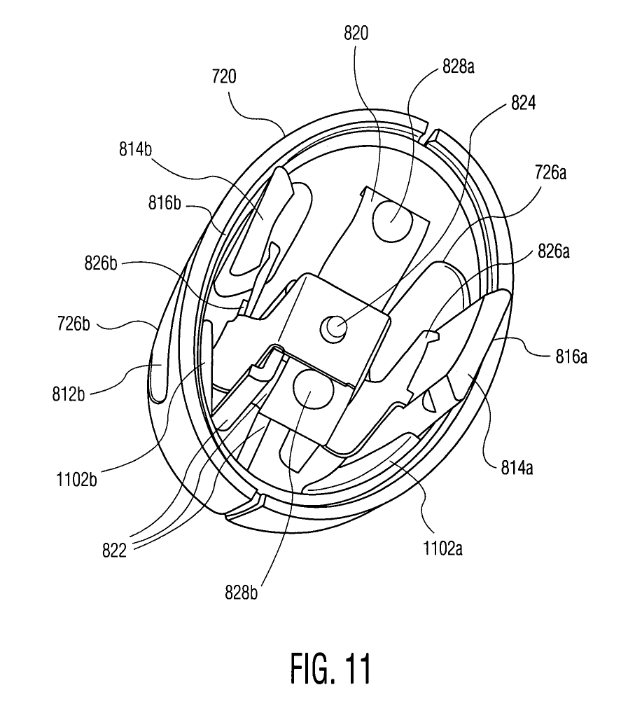

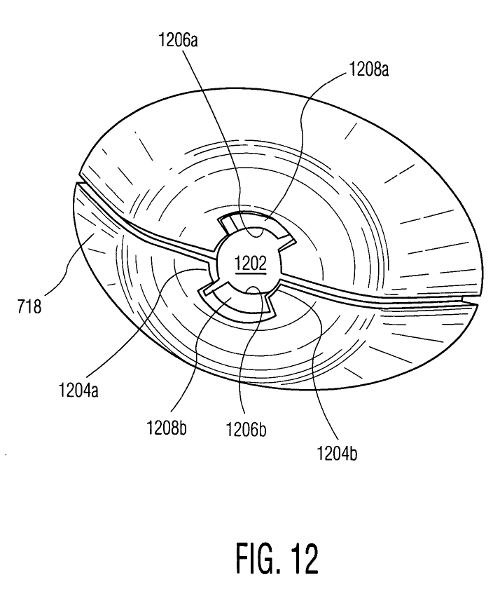

An alternative implementation of the top cover 718 which facilitates the use of a rotationally locking external connector is illustrated in FIG. 12. As described above, the top cover 718 includes an aperture 1202 which aligns with and provides access to the connector. As shown in FIG. 12, however, the cover includes 180° opposed shelf or lip portions 104a, 1204b located at or near the top surface of the top cover 718 at which the aperture 1202 has a relatively smaller diameter. Stated another way, the cover also includes 180° opposed material free regions 1206a, 1206b located at or near the top surface of the top cover 718 at which the aperture has a relatively larger diameter. Additional lips or shelves 1208a, 1208b which restrict the aperture to a smaller diameter are disposed below the material free regions 1206a, 1206b.

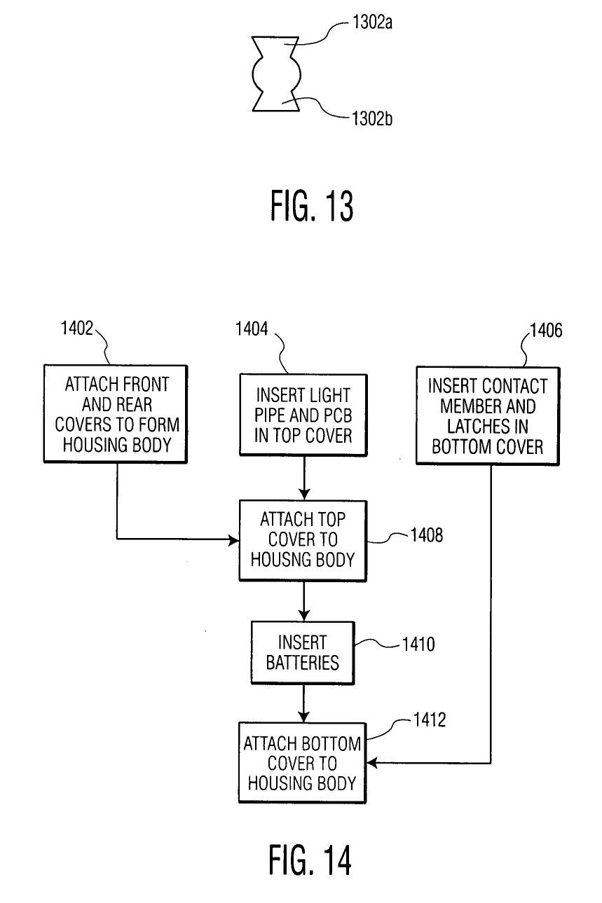

A portion of the housing of a corresponding external connector has the cross section shown in FIG. 13. The housing includes lips or shelves 1302a, 1302b which are sized to fit through the material free regions 1206a, 1206b. The location and depth of lips 1302a, 1302b are selected so that the connector may be inserted in the aperture 102 and rotated so as to prevent the external connector from being removed from the power supply 700. Though illustrated to provide a 90° rotationally locking connector, the aperture and external connector may readily configured to provide 180° or other desired locking actions. Such an arrangement may likewise be implemented in connection with cover 28.

In one embodiment, the front 714 and rear 716 covers and the latches 726 are provided in first color, while the top 718 and bottom covers 720 are provided in a second color. Logos, instructions, additional decorative features or other similar items may also be provided on the outer surface of the housings, for example through additional molded plastic pieces suitably fastened thereto. The top cover 718 especially may also be rendered translucent or transparent.

Still other variations are possible. For example, the power supply 700 may be configured to receive AAA, C, D, or other sized batteries. The power supply may also be configured to accept four (4) or more batteries, or only a single battery, provided that an electrically conductive path is provided between the cell's second terminal and the PCB 908.

Assembly of the power supply will now be described in relation to FIG. 14. At 1402, the front 714 and rear covers 716 are attached to form a housing body. In the illustrated embodiment, the covers are snapped together such that the protrusions 808 and recesses 810 engage.

At 1404, the light pipe 1002 and PCB 908 are inserted in the top cover 718. Stated another way, the top cover is placed over the light pipe 1002 and PCB 908. Note that the light pipe may be installed in either of two 1800 opposed positions. The PCB, however, is keyed and may be inserted in only a single rotational position.

At 1408, the top cover 718 is attached to the housing body. In the illustrated embodiment, the pieces are snapped together such that the attaching members 902 engage their corresponding protrusions 904. Note that the top cover 718 and the housing body can be attached in only a single rotational position.

At 1406, the latches 726a, 726b and the contact member 820 are installed in the bottom cover 720. The post 824 may be heat staked or otherwise deformed as desired.

At 1410, the batteries may optionally be inserted in the battery receiving region 802. The polarity members 910 prevent the negative terminal of an improperly inserted battery from making electrical contact with the battery contact 906a.

At 1412, the bottom cover 720 is attached to the housing body. Note that the bottom cover 720 may be installed in either of two 1800 opposed positions.

The bottom cover 720 may be removed by depressing the actuating portions 812a, 812b of the latches 726a, 726b until the engaging portions 814a, 814b disengage from their respective protrusions and moving the bottom cover 720 away from the remainder of the housing. The batteries are then removed from the battery receiving region through the resultant opening.

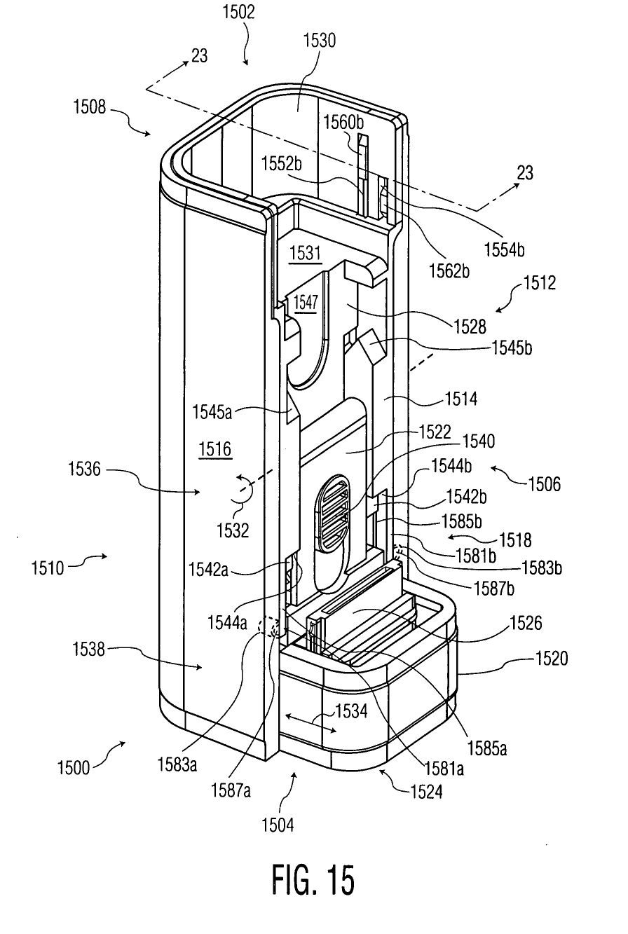

Turning now to FIG. 15, a portable power supply 1500 includes a top 1502, bottom 1504, front 1506, rear 1508, and first 1510 and second 1512 sides. As the power supply 1500 is readily portable, the foregoing descriptions are intended to provide a consistent frame of reference with which to describe the power supply 1500 itself and do not necessarily correspond to the reference frame of a user or otherwise to the external environment. As illustrated in FIG. 15, the power supply 1500 is adapted to receive two (2) AA size cells and has external dimensions of approximately 8.92 centimeters (cm) high×3.52 cm wide×2.36 cm deep. The power supply 1500 includes a body 1514, a battery cover 1516, and a connector carrier 1518 that are molded or otherwise formed using a polymer such as ABS.

Located inside the cover 1516 is a battery receiving region 1536. Located below the battery receiving region 1536 is a PCB receiving region 1538. The PCB receiving region 1538 receives a PCB that carries power supply circuitry that converts energy from the batteries to the voltage and/or current levels suitable for powering a battery powered appliance (not shown in FIG. 15). In one such implementation, the circuitry functions substantially as described above in relation to the circuit board 908 and charges secondary batteries of the portable appliance when the power supply 1500 is connected to the portable appliance. In another implementation, the voltage and/or current levels are selected to operate the battery powered appliance in an extended use mode in which the power supplied by the power supply 1500 is limited to a level that approximates a power drawn by the battery powered appliance in a typical operating mode or when operated according to typical usage patterns. When the appliance is so operated, the state of charge of the appliance batteries remains approximately constant. Such a configuration allows the portable appliance to be operated for a relatively extended time period while conserving the power supply's batteries. The portable appliance can then be recharged at a convenient time using an AC line powered or other suitable charger. Suitable functionality is also disclosed in commonly owned and co-pending U.S. patent application Ser. No. 11/360,789, filed Feb. 23, 2006 and entitled Power Supply for Battery Powered Devices, which application is expressly incorporated by reference in its entirety herein.

The connector carrier 1518 includes a protruding portion 1520 and a tongue portion 1522. FIG. 15 depicts the connector carrier 1518 in a first, open position in which the protruding portion 1520 protrudes generally forwardly from the front 1506 of the power supply 1500 at a location generally to the front of the PCB receiving region 1538. The bottom 1524 of the protruding portion also forms a base that supports the power supply in an upright position on a horizontal surface such as a desk or tabletop. In the illustrated embodiment, a bottom 1524 of the protruding portion is substantially flush with the bottom 1504 of the power supply 1500. Mounting feet or bosses may also be provided.

The protruding portion 1520 carries an electrical connector 1526 that matingly engages a corresponding connector of the electrical appliance, it being understood that the configuration and location of the connector 1526 ordinarily depend on the requirements of the electrical appliance. As illustrated in FIG. 15, the connector 1526 faces generally upwardly and is spaced forward from the front 1506 of the power supply so as to engage an electrical connector located on an underside of and spaced away from a rear of the appliance. Where the power supply 1500 is designed for use with appliances having different physical dimensions (as may occur, for example, in the case of a group or family of related appliance), the connector 1526 may also be slidably mounted to the protruding portion 1520 for movement in a direction 1534 that is substantially orthogonal to the front 1506 of the power supply 1500. For example, the connector 1526 may be positionable in a first position that is relatively near to the front of the tongue 1522, a second position that is relatively farther therefrom, and/or one or more intermediate positions.

The front face of the body 1514 includes a first material free region or channel 1528. While obscured by the tongue 1522, it will be appreciated that the first material free region 1528 also extends behind the tongue 1522 and the protruding portion 1520 so that the front of the tongue 1522 is recessed in or generally flush with the front 1506 of the power supply 1500 when the connector carrier 1518 is in the open position.

In the illustrated embodiment, the body 1514 also forms a second material free region 1530 located above the battery receiving region 1536. The second material free region 1530 is dimensioned to receive the protruding portion 1520 and the connector 1526 when the connector carrier is in a closed position. In the illustrated embodiment, the depth of the protruding portion 1520 is less than the depth of the body 1514. The second side of the body 1514 also includes material free regions such as slots 1552b, 1554b located in the area of the material free region 1530, the purpose of which will be described below. While not visible in FIG. 15, it will be understood that the first side of the body 1514 may include similar slots.

The connector carrier 1518 is movably attached to the body 1514 so as to be positionable in the open and closed positions. In the illustrated embodiment, the connector carrier 1518 is attached to the body 1514 (e.g., by way of a pin or pins, a snap fit, or the like) for pivotal motion over an angular range of about 180 degrees. The connector carrier pivots about an axis 1532 located equidistant from the top 1502 and bottom of the 1504 of the power supply 1500. The axis 1532 is located at a front of the body 1514 and slightly to the rear of the mid-point of the depth of the first material free region 1528.

The tongue 1522 also carries a user operable control or button 1540 that maintains the connector carrier 1518 in the open position. As illustrated, latch members 1542a, 1542b extend laterally from the button 1540 and engage corresponding first catches 1544a, 1544b formed in the body 1514. Corresponding second catches 1545a, 1545b that maintain the connector carrier 1518 in the closed position are also shown. To close the connector carrier 1518, the user moves the button 1540 downwardly to release the latch members 1542 from their respective catches 1544 and pivots the connector carrier about the axis 1532. Chamfered edges on the latch members 1542 and/or the catches 1544, 1545 allow the latch members 1542 to engage automatically when the user places the connector carrier 1518 in the desired position. A portion of the button 1540 protrudes outwardly from the tongue 1522; a corresponding material free region portion 1530 receives the protruding portion.

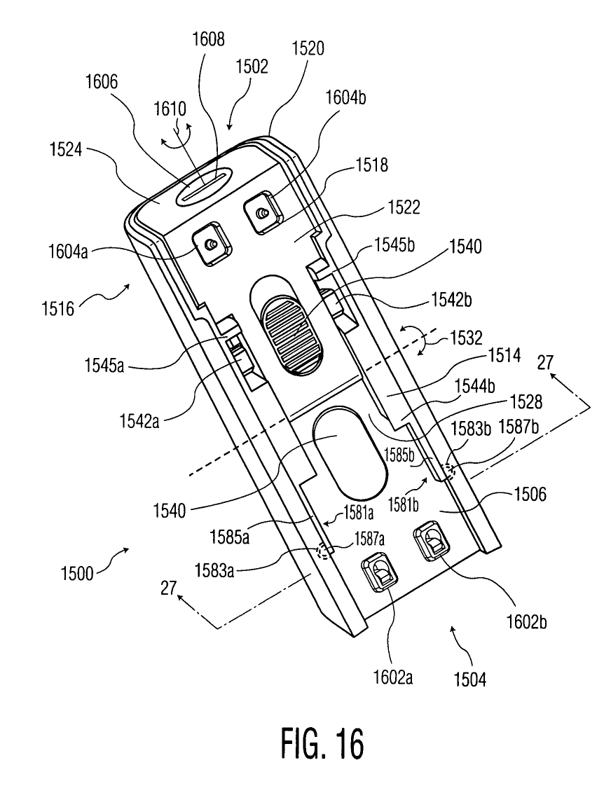

Turning now to FIG. 16, the connector carrier 1518 is pivotable to a second, closed position in which the protruding portion 1520 and the connector 1526 are received in the second material free region 1530. In the illustrated embodiment, the height of the body 1514 is established so that the bottom surface 1524 of the protruding portion 1520 is substantially flush with the top of the body 1514 when the connector carrier 1518 is in the closed position. The tongue 1522 is likewise received in the first material free region 1528 so as to be recessed in or substantially flush with the front 1506 of the power supply 1500. Thus, in the illustrated embodiment, the power supply 1500 takes the form of a generally rectangular prism when the connector carrier 1518 is in the closed position, with the cover 1516 and body 1514 tending to protect the connector 1526 from physical damage and/or contamination.

A user actuated control 1606 is recessed in or substantially flush with the surface 1524 of the protruding portion 1520. The control 1606 is in operative mechanical communication with the connector 1526 so that the user may vary the position of the connector 1526 in the direction 1534 by turning the control 1606 about an axis of rotation 1610. To facilitate rotation, the control 1606 includes a slot or depression 1608 that is sized to receive a coin, key or other similar object. In one implementation, the user moves the connector 1526 to the first position by turning the control 1606 to an end of travel in one direction and to the second position by turning the control 1606 to an end of travel in the other direction.

The control 1606 may also provide tactile feedback to the user when the connector 1526 is in one or more predefined positions. Such feedback is especially useful where the connector 1526 is positionable so as to receive electrical appliances having three (3), four (4), or more known connector spacing requirements, or where the first and second positions of the connector 1526 do not correspond to the end of travel of the control 1606. Ease of use is facilitated if the control 1606 is operable with the connector carrier 1518 disposed in either the open or closed positions. Where the connector 1526 is movable, and as illustrated in FIG. 15, the material free region portion 1531 is sized to receive the connector 1526 in its various possible positions.

As noted above, the control or button 1540 maintains the contact support 1518 in the closed position. To open the connector carrier 1518, the user slides the button 1540 generally upwardly to release the latch members 1542 from their respective catches 1544. A material free region 1650 again receives a protruding portion of the button 1540.

A first pair of electrical contacts 1602a, 1602b is accessible from the front surface 1506 of the body 1514 and is electrically connected to the output of the power supply circuitry. The connector carrier 1518 carries a corresponding second pair of electrical contacts 1604a, 1604b that are electrically connected to the desired pins or contacts of the connector 1526. The contacts 1602, 1604 are located so that the corresponding contacts make electrical contact when the connector carrier 1518 is in the open position, hence forming an electrical circuit between the output of the power supply circuitry and the connector 1526. While two sets of contacts are shown, it will be understood that additional contacts may be provided, for example where the power supply circuitry provides multiple outputs or where additional or different signals are provided.

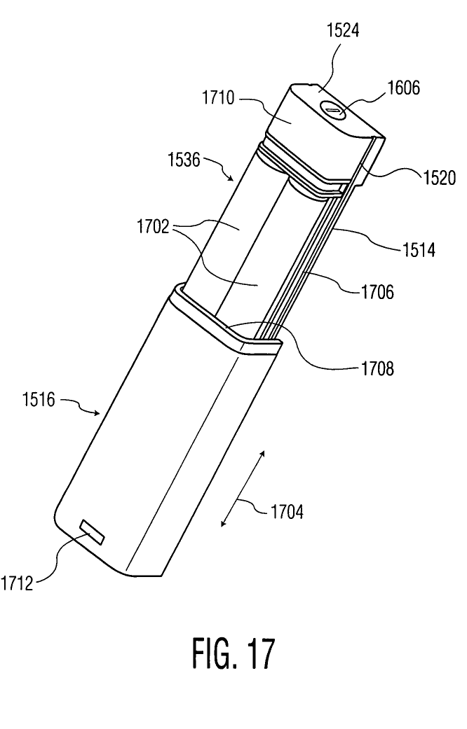

Turning now to FIG. 17, the cover 1516 is depicted in an open position that allows the user to selectively insert and/or remove the batteries 1702 from the battery receiving region 1536. In the illustrated embodiment, the battery receiving region 1536 receives two (2) generally cylindrical AA-size batteries located side by side so as to occupy a first width. The protruding portion 1520 has a width that is approximately equal to the width occupied by the batteries 1702. The cover 1516 is attached to the body 1514 for slidable motion in a direction 1704 substantially parallel to the longitudinal axes of the batteries 1702 and orthogonal to the axis 1532 and direction 1534, for example by sliding along rails 1706 formed along the sides of the body 1514. As illustrated, the cover 1516 includes a generally U-shaped cross section, the interior 1708 of which conforms to and is slightly larger than the exterior 1710 cross section of the protruding portion 1520. The cover 1516 also carries an optically light transmissive portion 1712. In one implementation, the cover 1516 is fabricated from a light transmissive polymer and the thickness of the transmissive portion is relatively less than that of the surrounding material. In another, a light transmissive member is inserted in a material free region of the cover 1516.

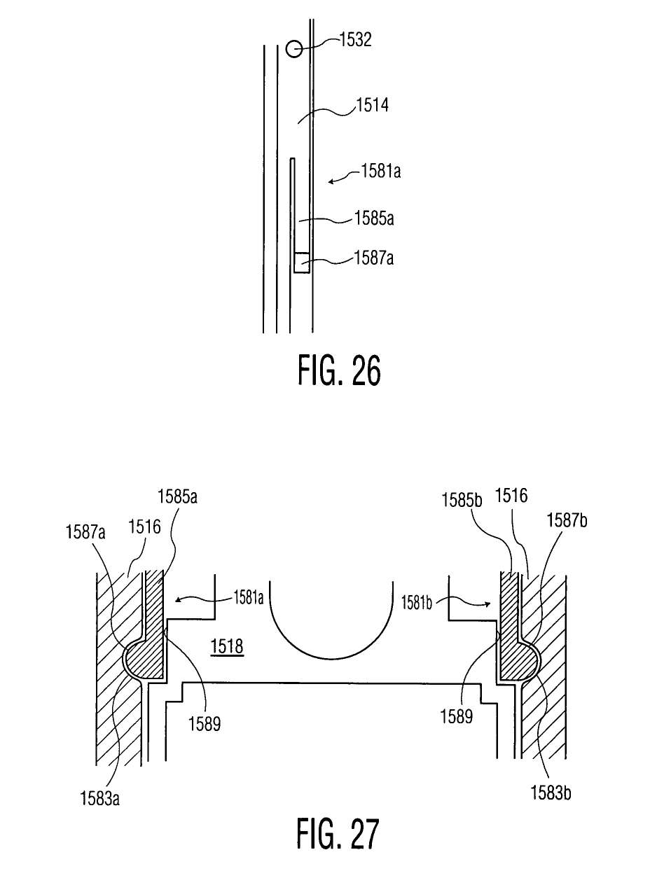

The power supply 1500 may also be configured to prevent the user from opening the cover 1516 when the connector 1520 is in the open position. With reference to FIGS. 15, 16, 26, and 27, the body 1514 includes a latch having first 1581a and second 1581b outwardly facing latch members that engage corresponding material free regions or catches 1583a, 1583b located the inner side walls of the cover 1516. Each latch member 1581 includes a resilient, downwardly extending arm 1585a, 1585b having a protrusion 1587a, 1587b formed at its distal end. When the connector 1520 is in the closed position, sliding the cover 1516 toward the open position urges the latch members 1581 generally inwardly so that the protrusions 1587 disengage from their respective catches 1583 thus allowing the cover 1516 to open. When the connector 1526 is in the open position, however, the connector carrier side walls 1589 prevent inward motion of the latch members 1581, thereby enabling the latch and preventing the cover 1516 from opening. Note that, in the illustrated embodiment, the latch members 1581 also prevent the connector 1526 from being placed in the open position when the cover 1516 is open.

Other cover 1516 configurations are also contemplated. For example, the cover 1516 may be substantially permanently affixed to the body 1514, with access to the battery receiving region 1536 provided through a second, removable cover located on the back 1508 of the cover 1516.

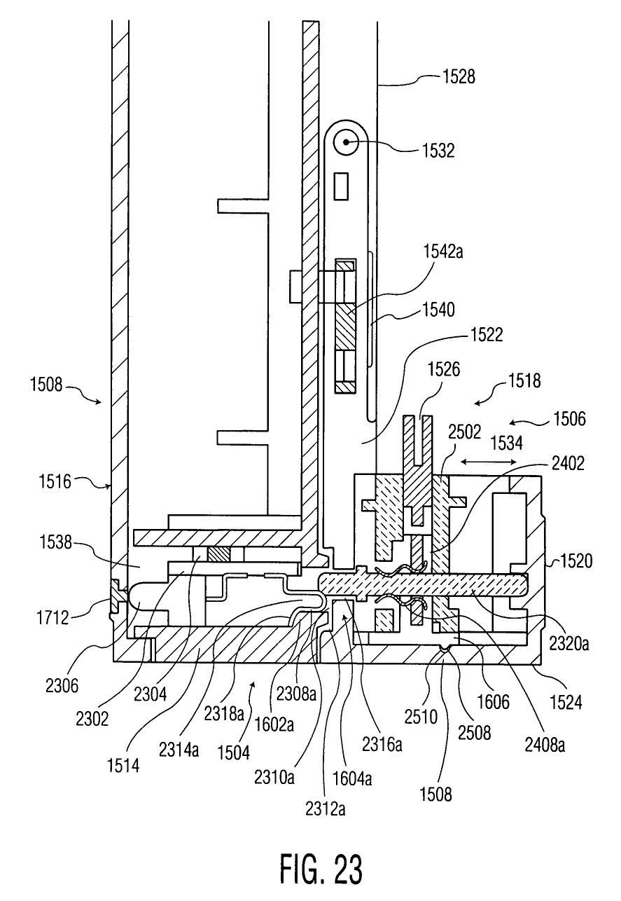

Turning now to FIG. 23, the battery cover 1516 is depicted in the closed position and the connector carrier 1518 is depicted in the open position. A printed circuit board 2302 is located in the printed circuit board receiving region 1538 and carries the desired power supply circuitry. The circuit board 2302 carries upwardly facing battery contacts 2304 that make electrical contact with the terminals of batteries received in the battery receiving region. The circuit board also carries a human visible indicator 2306 such as a light emitting diode (LED) 2308 that indicates an operational state of the power supply 1500, for example to indicate that the power supply circuit is charging the battery of an appliance connected to the power supply 1500. The indicator 2306 is in optical communication with the transmissive portion 1712 so as to be visible through the cover. A printed circuit board cover (omitted for clarity of illustration) located inwardly of the cover 1516 may also be provided.

Construction of the connectors 1602, 1604 will now be described, it being understood that the section plane of FIG. 23 is located at the approximate lateral mid-point of the connectors 1602a, 1604a and that connectors 1602b, 1604b are similarly constructed. The body 1514 includes a first material free region 2314a extending from the printed circuit board receiving region 1538 to the front of the body 1514. A first forward facing protrusion 2310a surrounds the material free region 2314a. The connector carrier includes a corresponding, slightly larger depression 2312a. A material free region 2316a extends through the wall of the connector carrier 1518 at the location of the depression 2312a.

A spring electrical contact 2318a is carried by the circuit board and extends into the material free region 2314a of the body 1514. To reduce the likelihood of an inadvertent short circuit when the connector carrier is in the closed position, the front-most portion of the contact 2318a does not reach the front surface of the protrusion 2312 and hence remains recessed in the front wall of the body 1514.

The connector carrier 1518 carries a corresponding contact 2320a such as a generally cylindrical pin. The contact 2320a extends through the material free region 2316a and into the material free region 2314a, where it makes electrical contact with the spring contact 2308a.

Note that the dimensions of the protrusion 2310a, depression 2312a, and the locations of the contacts 2308a, 2320a and their location in the depth direction relative to the axis 1532 should be selected so that the outwardly extending portion of the contact 2320a does not extend past the front 1506 surface of the body 1514 when the connector carrier 1518 is in the closed position. Such an arrangement tends to protect the contact 2320a and can be exploited to allow the front 1506 of the power supply 1500 to be placed flat on a table or other substantially planar surface without interference from the contact 2320a.

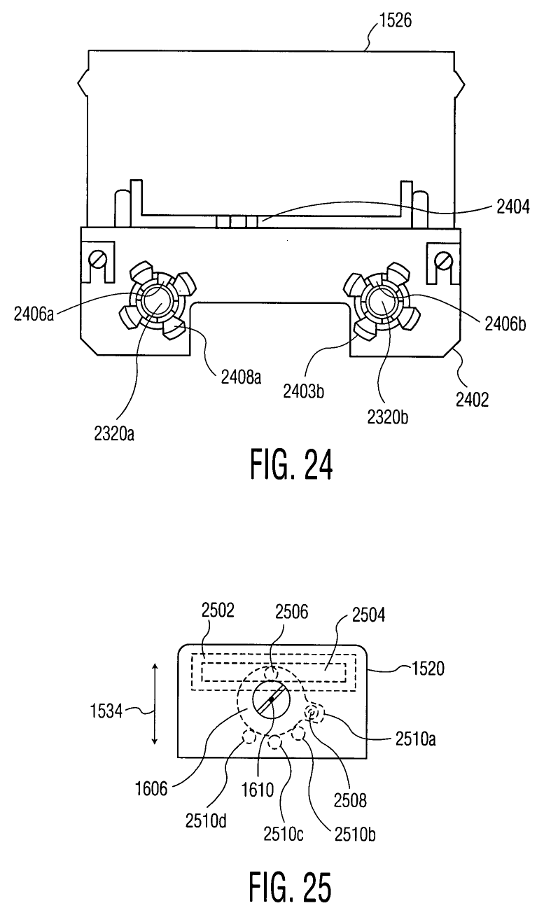

The electrical connections between the connector 1526 and the contacts 2320a, 2320b will now be described with additional reference to FIG. 24. Note that various housings, covers, and other components are omitted for clarity of explanation. The connector 1526 is suitably secured to a PCB 2402, for example by way of screws or other fasteners. Electrical connections are provided by connector pins 2404 soldered to the PCB 2402. The circuit board also includes first and second material free regions 2406a, 2406b that correspond to the locations of the connectors 2320a, 2320b. Sliding contacts 2408a, 2408b having generally inwardly facing contact portions are soldered to the PCB 2402 so the contact portions make a sliding electrical contact with the connectors 2320a, 2320b. Traces carried by the PCB 2402 provide the desired electrical connections between the connectors 2320 and the connector pins 2404.

Note that the PCB 2402 may also carry additional components or circuitry. In one such example, the electrical appliance may seek to identify the power supply 1500 as a compatible device before accepting power therefrom, for example by detecting the presence of resistors or other identification components. Such components may be located on the PCB 2402 and connected to the connector 1526 via the connector pins 2404. As another example, the PCB 2402 may carry some or all of the power supply circuitry.

As noted above, the connector 1526 is movable with respect to the connector carrier 1518. With reference to FIGS. 15, 23, and 25, housing 2502 houses a bottom portion of the connector 1526, and the PCB 2402. A slot 2504 at the bottom of the housing 2502 receives a first peg 2506 that extends upwardly from the control 1606. The first peg 2506 is located eccentric to the axis of rotation 1610 so that rotation of the control 1606 varies the position of the first peg 1506 in the direction 1534. The first peg 2506 in turn engages the housing 2502, thus causing the connector to also move in the direction 1534. A second eccentrically located peg 2508 extends downwardly from the control 1606 and engages depressions 2510a, 2510b, 2510c, 2510d formed in the upper surface of protrusion 1520 bottom wall, thus providing the user with tactile feedback when the connector 1516 is located at predefined positions with respect to the front of the power supply.

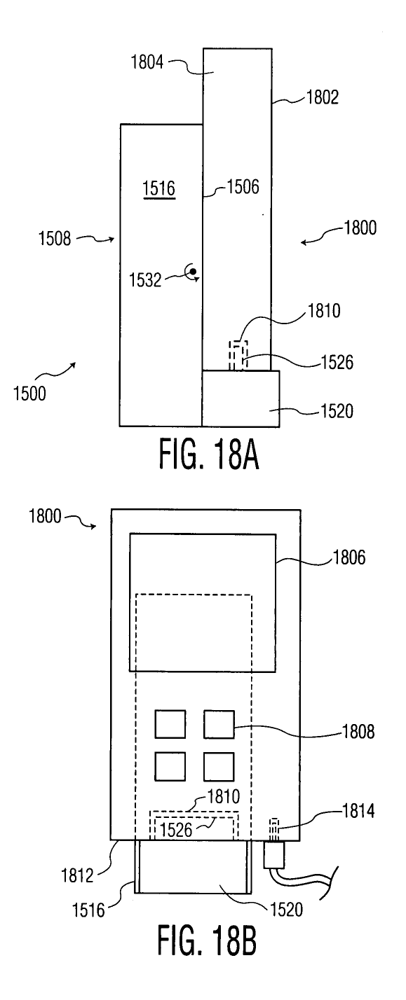

FIGS. 18A and 18B depict a portable appliance 1800 such as a portable media player connected to the power supply 1500. As illustrated, the portable appliance 1800 is configured as a rectangular prism having front 1802 and rear 1804 surfaces. An operator interface such as a display 1806 and/or buttons or keys 1808 are disposed on the front surface 1804. The portable appliance 1800 also carries a rechargeable energy source such as one or more lithium ion (Li Ion) or other secondary batteries.

The portable appliance 1800 includes a first electrical connector 1810 that is accessed from a bottom 1812 of the portable appliance 1800. The first electrical connector includes at least first and second power pins or contacts in operative electrical communication with the appliance's rechargeable energy source. The appliance 1800 may also include a second connector 1814 that is accessed from the bottom 1812 of the appliance 1800. In the case of a portable music player, for example, the second connector 1814 may be a headphone jack.

As illustrated in FIGS. 18A and 18B, the connector 1526 of the power supply 1500 matingly engages the first connector 1810 of the portable appliance 1800 so as to receive energy from the power supply 1500. The rear surface 1804 of the portable appliance 1800 is supported by the front surface 1506 of the power supply 1500. Operating controls located on the front 1802 and/or sides of the portable appliance 1800 remain accessible to the user. Also as illustrated, the power supply 1500 has a width less than the width of the appliance 1800. As the second connector 1814 is located laterally of the power supply 1500, the second connector 1814 remains accessible to the user while the portable appliance 1800 is installed on the power supply 1500.

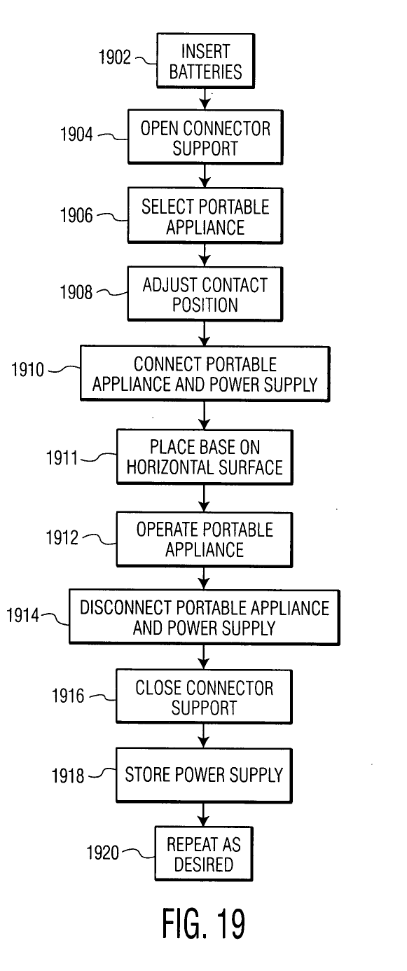

Operation of the power supply 1500 will now be described in relation to FIG. 19.

At 1902, the user accesses the battery receiving region 1536, for example by sliding the cover 1516 downwardly with respect to the body 1514. After inserting the desired batteries, the user closes the cover 1516.

At 1904, if the connector carrier 1518 is in the closed position, the user opens the connector carrier at 1518 so as to expose the connector 1526.

At 1906, the user selects a desired portable appliance 1800.

If necessary, the user adjusts the position of the connector 1526 to accommodate the selected appliance 1800 at 1908. The appliance 1800 may be selected and the connector 1526 adjusted before inserting the batteries 1702 and/or opening the connector carrier 1518.

At 1910, the user connects the portable appliance 1800 and the power supply 1500 so that the respective connectors 1526, 1810 engage. The power supply circuitry thus supplies the desired energy to the appliance 1800.

At 1911, the user places the base of the power supply 1500 on a horizontal surface. Note that the base of the power supply may also be placed on the horizontal surface prior to connecting the two devices.

At 1912, the user operates the portable appliance 1800 as desired.

At 1914, the user disconnects the portable appliance 1800 and the power supply 1500. If desired, the user may continue to operate the portable appliance 1800.

At 1916, the user places the connector carrier 1518 in the closed position.

At 1918, the user stores the power supply 1500 as desired. For example, the user may place the power supply in a purse or backpack, a pocket of a shirt, pants, jacket, or other article of clothing, an automobile glove box or other storage area, a drawer, a school locker, or the like.

At 1920, the process is repeated as desired.

Still other alternatives and variations are contemplated. For example, the power supply 1500 may be configured to receive other numbers and sizes of batteries and to power various other portable devices. It should also be noted that the material free region 1530, 1531 may be defined by the cover 1516, either alone or in cooperation with the body 1514. Some or all of the walls may also be omitted. Other configurations of the connectors 1602, 1604a are also contemplated. For example, the contacts 2302 may be spring loaded or otherwise urged in the direction of the contacts 2318. The contacts 2318 may also be configured as conductive plugs that are recessed in the material free regions 2314. Electrical connections to the connector 1526 may also be provided by way of a flexible circuit. It should also be noted that the connector carrier 1518 may also be mounted for slidable motion into a material free region located generally below the battery receiving region.

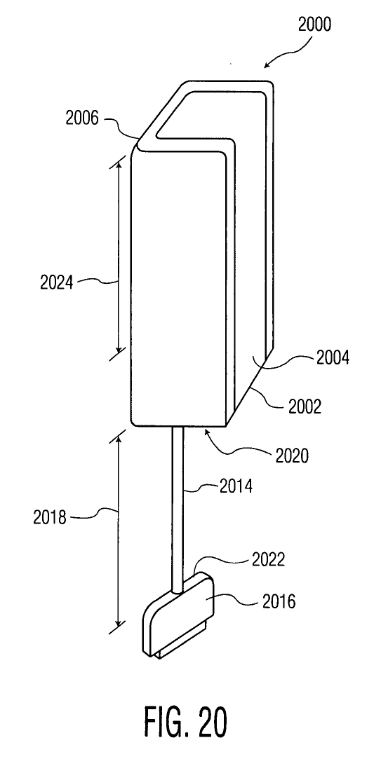

FIGS. 20 and 21 illustrate another variation of a power supply 2000. The construction and form factor of the power supply 2000 are similar to that of the power supply 1500, with the movable connector carrier 1518 and the first 1528 and second 1530 material free regions being omitted. As a consequence, the height and depth of the power supply 2000 may be less then those of the power supply 1500. The body 2002 also includes a substantially planar front surface 2004. The cover 2006 is again mounted for slidable motion relative to the body 2002, for example along rails 2108, so as to allow the user to access the battery receiving region 2010 for inserting and removing the batteries 2012.

Electrical connections to the portable appliance are provided by way of a flexible cable 2014. A connector 2016 located at the distal end of the cable 2014 matingly engages a corresponding connector of the portable appliance. In one embodiment, the proximal end of the cable 2014 is permanently connected to the power supply 2000. In another, the proximal end of the cable 2014 is removably connected to the power supply 2000 via suitable electrical connector.

To facilitate the opening and closing of the cover 2006, the length 2018 of the cable 2014 (e.g., the distance from the underside 2020 of the power supply 1500 to the shoulder 2022 of the connector 2016) is preferably approximately equal to or greater than the distance 2024 traveled by the cover 2006 when moved between the open and closed positions.

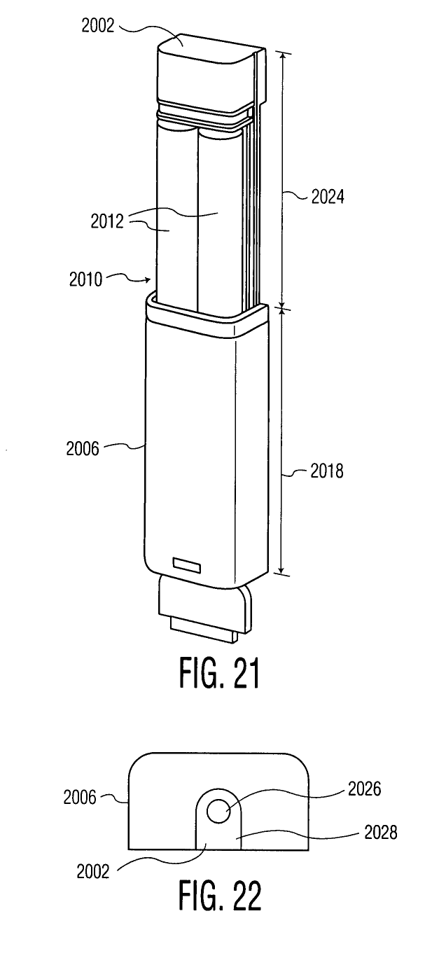

FIG. 22 presents a bottom view of the power supply 2000. The cover 2006 includes a material free region 2028. A connector 2026 is carried by the body 2002 and accessed through the material free region 2028 so that a mating connector on the proximal end of the cable 2014 can engage the connector as desired and to allow opening and closing of the cover 2006 when the cable 2014 is connected. As noted above, the connector 2026 may be omitted and the cable 2014 permanently connected to the power supply 1500.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the Doctrine of Equivalents.

What is claimed is:

1. A portable battery powered power supply that supplies electrical energy to an electrical appliance, the power supply comprising:
a housing including a battery receiving region;
power supply circuitry that receives electrical energy from a battery received in the battery receiving region;
an electrical connector attached for pivotal motion with respect to the housing, wherein the connector is pivotable to a first position for connecting to a corresponding connector of the electrical appliance and a second position.

2. The power supply of claim 1 wherein the connector is attached for pivotal motion over an angular range of about 180 degrees.

3. The power supply of claim 1 wherein the housing includes first and second spaced apart ends and the connector pivots about an axis located approximately midway between the first and second ends.

4. The power supply of claim 3 including a connector carrier that pivotally attaches the connector to the housing, wherein the connector carrier includes a face, and the face is substantially flush with the first end when the connector is in the first position and the second end when the connector is in the second position.

5. The power supply of claim 1 wherein the housing includes a front face and the connector is located to the front of the front face when the connector is in the first position and to the rear of the front face when the connector is in the second position.

6. The power supply of claim 5 wherein the battery receiving region and the power supply circuitry are located to the rear of the front face, and the battery receiving region is located between the connector and the power supply circuitry when the connector is in the second position.

7. The power supply of claim 5 wherein the front face supports a face of the electrical appliance when the corresponding connector of the electrical appliance is connected to the electrical connector.

8. The power supply of claim 1 wherein the housing defines a material free region that receives the connector when the connector is in the second position.

9. The power supply of claim 1 wherein the power supply forms a rectangular prism when the connector is in the second position.

10. The power supply of claim 1 including a connector carrier that pivotally attaches the connector to the housing, wherein the connector is movably attached to the connector carrier so as to connect to a corresponding connector of electrical appliances having a plurality of exterior dimensions.

11. The power supply of claim 1 including a connector carrier that pivotally attaches the connector to the housing, wherein the housing includes a face and the connector is movably attached to the connector carrier so that the distance between the connector and the face when the connector carrier is in the first position is variable.

12. The power supply of claim 1 wherein the connector is movably attached to the connector carrier for movement to at least three pre-defined, user selectable positions.

13. The power supply of claim 1 including a connector carrier that pivotally attaches the connector to the housing, wherein the housing includes a first end and the connector carrier includes a face, and wherein the first end and the face cooperate to form a base that supports the power supply on a horizontal surface when the connector is in the first position.

14. The power supply of claim 1 including a first electrical contact, a second electrical contact, and a connector carrier that pivotally attaches the first electrical connector to the housing, wherein the first electrical contact is carried by the housing, the second electrical contact is carried by the connector carrier, and the first electrical contact makes an electrical contact with the second electrical contact when the connector is in the first position.

15. The power supply of claim 1 including a latch that retains the connector in the first and second positions.

16. The power supply of claim 1 wherein the housing includes
a body;
battery receiving region cover slidably attached to the body.

17. The power supply of claim 1 wherein the power supply circuitry includes battery charger circuitry.

18. A method comprising:
pivoting an electrical connector of a portable battery powered power supply to an open position;
connecting a corresponding connector of an electrically powered appliance to the electrical connector;
using the power supply provide electrical energy to the electrical appliance;
disconnecting the corresponding connector from the electrical appliance;
pivoting the electrical connector to a closed position in which the electrical connector is protected by a housing of the power supply.

19. The method of claim 18 including:
selecting an electrical appliance;
adjusting a position of the connector relative to the housing as a function of the selected appliance;

20. The method of claim 19 including adjusting the position of the connector while the connector is in the closed position.

21. The method of claim 18 wherein the appliance includes a connector carrier, pivoting includes pivoting the connector carrier so that the carrier and the housing form a base that supports the power supply on a horizontal surface when the connector carrier is in the open position, and the method includes
placing the base on the horizontal surface.

22. The method of claim 21 including performing the step of connecting prior to the step of placing.

23. The method of claim 18 wherein the power supply includes a battery receiving region, a cover that allows a user to access the battery receiving region, and wherein pivoting the connector to the open position enables a latch that prevents the user from opening the cover.

24. The method of claim 18 wherein the battery powered appliance includes a portable media player.

25. A portable battery powered power supply that supplies electrical energy to an electrical appliance, the power supply comprising:
a housing including a battery receiving region that receives a generally cylindrical battery along a longitudinal axis and a top, a bottom, and a front;
power supply circuitry that receives electrical energy from a battery received in the battery receiving region, wherein the power supply circuitry is located between the bottom of the housing and the battery receiving region;
a connector that provides an electrical connection to a corresponding connector of the electrical appliance;
a connector carrier including a protruding portion that carries the connector, wherein the connector carrier is attached to the housing for pivotal motion about a pivot axis that is perpendicular to the longitudinal axis, and wherein the connector carrier is movable to first position in which the protruding portion protrudes forward from the front of the housing at a location to the front of the power supply circuitry and to a second position in which the protruding portion protrudes rearward from the front of the housing at a location above the battery receiving region.

26. The portable battery powered power supply of claim 25 wherein the protruding portion and the bottom of the housing cooperate, when the connector carrier is in the first position, to form a base that supports the power supply and the electrical appliance in an upright position on a horizontal surface.

27. The portable battery powered power supply of claim 25 wherein the corresponding electrical connector is accessed from the bottom of and spaced away from the rear of the electrical appliance, the electrical connector faces upwardly when the connector carrier is in the open position so as to engage the corresponding connector, and the electrical connector is spaced away from the front of the power supply so that the front power supply supports the rear of the appliance when the connectors are so engaged.

28. The portable battery powered power supply of claim 25 wherein the spacing between the front of the power supply and the electrical connector is user-adjustable.

29. The portable battery powered power supply of claim 25 wherein the housing includes a body and a cover, the connector carrier is pivotally attached to the body, and the cover is slidably attached to the body for motion in a direction parallel to the longitudinal axis.

30. The portable battery powered power supply of claim 25 wherein the battery receiving region receives two AA-size batteries located side by side so as to occupy a first width and the protruding portion has a width that is less than or approximately equal to the width occupied by the batteries.

31. The portable battery powered power supply of claim 25 wherein the housing defines a material free region that receives the connector when the connector carrier is in the closed position.

32. The portable battery powered power supply of claim 31 wherein the housing surrounds the material free region on exactly four sides.

33. A portable battery powered power supply that supplies electrical energy to an electrical appliance that includes a housing having a bottom, a first upstanding surface, and an appliance electrical connector that is accessible from the bottom of the appliance and spaced away from the upstanding surface, the power supply comprising:
a housing including a battery receiving region, a bottom, and a second upstanding surface;
power supply circuitry that receives electrical energy from a battery received in the battery receiving region;
an upwardly facing electrical connector that engages the appliance electrical connector, wherein the spacing between the upwardly facing connector and the second upstanding surface is user adjustable to selectively accommodate a first electrical appliance in which the appliance electrical connector is spaced away from the first upstanding surface by a first distance and a second electrical appliance in which the appliance electrical connector is spaced away from the first upstanding surface by a second distance that is different from the first distance.

34. The power supply of claim 33 including a user operable control that allows the user to the adjust the spacing between the upwardly facing connector and the second upstanding surface, wherein the control provides the user with a tactile indication when the spacing is adjusted to at least first and second predetermined positions.
